(19) United States
(12) Patent Application Publication
(10) Pub. No.: US 2021/0084178 A1
(43) Pub. Date: Mar. 18, 2021

(54) IMAGE READING SYSTEM

(71) Applicant: FUJI XEROX CO., LTD., Tokyo (JP)

(72) Inventors: Satoshi KAWAMURA, Kanagawa (JP); Masafumi ASADA, Kanagawa (JP); Yuki SHIMIZU, Kanagawa (JP)

(73) Assignee: FUJI XEROX CO., LTD., Tokyo (JP)

(21) Appl. No.: 16/776,514

(22) Filed: Jan. 30, 2020

(30) Foreign Application Priority Data
Sep. 18, 2019 (JP) 2019-169830

(51) Int. Cl. H04N 1/00; H04N 1/387

(52) U.S. Cl. CPC H04N 1/00477; H04N 1/387; H04N 1/00352; H04N 1/00488

(57) ABSTRACT

An image reading system includes a terminal apparatus and an image reading apparatus that communicates data with the terminal apparatus and reads a sheet. The terminal apparatus includes an operation instruction unit that instructs the image reading apparatus to perform an operation. Either the terminal apparatus or the image reading apparatus includes a notification unit that notifies a user of completion of reading of the sheet and a next sheet instruction unit used by the user to determine whether to read a next sheet and include the next sheet in a resultant file in which the sheet is included.

### CROSS-REFERENCE TO RELATED APPLICATIONS

This application is based on and claims priority under 35 USC 119 from Japanese Patent Application No. 2019-169830 filed Sep. 18, 2019.

### BACKGROUND

### (i) Technical Field

The present disclosure relates to an image reading system.

### (ii) Related Art

Japanese Unexamined Patent Application Publication No. 2016-019061 discloses an image reading apparatus capable of connecting to a server over a network and reading an image of a sheet in accordance with a reading instruction transmitted from a user terminal through the server. The image reading apparatus includes reading means for reading the image of the sheet, display means for, after the reading means reads the image of the sheet in accordance with the reading instruction from the user terminal, displaying information for prompting a user to input an instruction relating to reading of a next sheet, and input means for receiving the instruction input by the user in response to the information displayed by the display means.

Japanese Unexamined Patent Application Publication No. 2004-236149 discloses an image processing system including an information processing terminal and an image processing apparatus connected to each other by interface means for communicating information. The image processing apparatus includes reading means having an automatic document feeder (ADF) method, in which sheets on a document feeder are fed and read one by one, and a platen method, in which a sheet disposed on a platen glass is read, reading control means for reading a sheet using the ADF method or the platen method in response to a scanning instruction from the information processing terminal, and image transfer means for transferring an image read by the reading control means to the information processing terminal. The information processing terminal includes scanning instruction means for selecting the ADF method or the platen method as a method to be used by the image processing apparatus to read a sheet, image reception means for receiving, in response to the scanning instruction, the image transferred from the image processing apparatus, display determination means for determining, in accordance with the method selected, whether to display a reminder of additional scanning after the image is received, additional scanning display means for displaying, if the display determination means determines that the reminder of the additional scanning is to be displayed, the reminder of the additional scanning, and additional scanning instruction means for, if it is determined through the additional scanning display means that the additional scanning is to be performed, instructing the image processing apparatus to perform scanning.

Japanese Unexamined Patent Application Publication No. 2018-026658 discloses an image forming apparatus including display control means for displaying, on display means, a reduced image of a part or the entirety of a page included in a first document and a document addition display component, which is used to add a second document to the first document.

### SUMMARY

Aspects of non-limiting embodiments of the present disclosure relate to an image reading system capable of merging an already read sheet and a sheet to be read next together as a single resultant file without using operation instruction means for requesting an operation provided for the image reading apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image reading system including a terminal apparatus and an image reading apparatus that communicates data with the terminal apparatus and reads a sheet. The terminal apparatus includes an operation instruction unit that instructs the image reading apparatus to perform an operation. Either the terminal apparatus or the image reading apparatus includes a notification unit that notifies a user of completion of reading of the sheet and a next sheet instruction unit used by the user to determine whether to read a next sheet and include the next sheet in a resultant file.

### BRIEF DESCRIPTION OF THE DRAWINGS

Exemplary embodiments of the present disclosure will be described in detail based on the following figures, wherein:

FIG. 1 is a side view of an image forming apparatus and a terminal apparatus included in an image reading system according to exemplary embodiments of the present disclosure;

FIG. 2 is a block diagram illustrating a control unit of the terminal apparatus according to the exemplary embodiments of the present disclosure;

FIG. 3 is a block diagram illustrating a control unit of the image forming apparatus according to the exemplary embodiments of the present disclosure;

FIG. 4 is a diagram illustrating an operation flow of the image reading system according to a first exemplary embodiment of the present disclosure;

FIG. 5 is a sequence diagram illustrating the operation flow of the image reading system according to the first exemplary embodiment of the present disclosure;

FIG. 6 is a diagram illustrating an operation flow of the image reading system according to a second exemplary embodiment of the present disclosure;

FIG. 7 is a sequence diagram illustrating the operation flow of the image reading system according to the second exemplary embodiment of the present disclosure;

FIG. 8 is a diagram illustrating an operation flow of the image reading system according to a third exemplary embodiment of the present disclosure;

FIG. 9 is a sequence diagram illustrating the operation flow of the image reading system according to the third exemplary embodiment of the present disclosure;

FIG. 10 is a diagram illustrating an operation flow of the image reading system according to a fourth exemplary embodiment of the present disclosure;

FIG. 11 is a sequence diagram illustrating the operation flow of the image reading system according to the fourth exemplary embodiment of the present disclosure;

FIG. 12 is a diagram illustrating an operation flow of the image reading system according to a fifth exemplary embodiment of the present disclosure;

FIG. 13 is a sequence diagram illustrating the operation flow of the image reading system according to the fifth exemplary embodiment of the present disclosure;

FIG. 14 is a diagram illustrating an operation flow of the image reading system according to a sixth exemplary embodiment of the present disclosure;

FIG. 15 is a sequence diagram illustrating the operation flow of the image reading system according to the sixth exemplary embodiment of the present disclosure;

FIG. 16 is a table illustrating patterns used to extract parts of a sheet in the image reading system according to the sixth exemplary embodiment of the present disclosure;

FIG. 17 illustrates a first specific example of the patterns used to extract parts of a sheet in the image reading system according to the sixth exemplary embodiment of the present disclosure;

FIG. 18 illustrates a second specific example of the patterns used to extract parts of a sheet in the image reading system according to the sixth exemplary embodiment of the present disclosure;

FIG. 19 is a diagram illustrating an operation flow of the image reading system according to a seventh exemplary embodiment of the present disclosure;

FIG. 20 is a sequence diagram illustrating the operation flow of the image reading system according to the seventh exemplary embodiment of the present disclosure;

FIG. 21 is a diagram illustrating an operation flow of the image reading system according to an eighth exemplary embodiment of the present disclosure;

FIG. 22 is a sequence diagram illustrating the operation flow of the image reading system according to the eighth exemplary embodiment of the present disclosure;

FIG. 23 is a diagram illustrating an operation flow of the image reading system according to a ninth exemplary embodiment of the present disclosure;

FIG. 24 is a sequence diagram illustrating the operation flow of the image reading system according to the ninth exemplary embodiment of the present disclosure;

### DETAILED DESCRIPTION

Next, exemplary embodiments of the present disclosure will be described in detail with reference to the drawings.

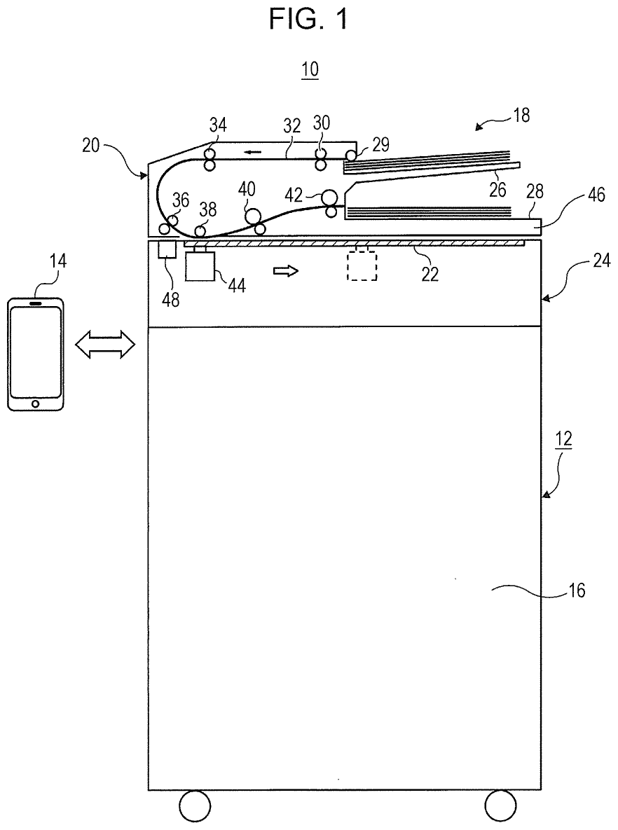

FIG. 1 illustrates an image reading system 10 according to the exemplary embodiments of the present disclosure. The image reading system 10 includes an image forming apparatus 12 and a terminal apparatus 14.

The image forming apparatus 12 includes an image forming apparatus body 16 and an image reading device 18.

The image forming apparatus body 16 forms images on a supplied recording medium and outputs the recording medium.

The image reading device 18 is provided over the image forming apparatus body 16. The image reading device 18 includes an ADF 20 and a reader 24 that reads a sheet fed by the ADF 20 or a sheet disposed on a platen glass 22.

The ADF 20 includes a document support 26 on which a set of sheets is disposed and an output tray 28 that is provided below the document support 26 and to which a recording medium subjected to reading is output. The ADF 20 also includes a feed roller 29 that feeds the sheets on the document support 26. A separation mechanism 30 that feeds the sheets one by one is provided downstream of the feed roller 29.

Conveyor rollers 34 and 36, a platen roller 38, conveyor rollers 40, and output rollers 42 are provided downstream in this order along a document path 32, along which the sheets are conveyed. The platen roller 38 pushes downward a sheet being read by the reader 24. The output rollers 42 convey and output the sheets read by the reader 24.

An image reading unit 44 is provided under the platen glass 22. The image reading unit 44 stays still under the platen roller 38 in order to read a sheet fed by the ADF 20 (ADF mode) or moves along the platen glass 22 in order to read a sheet disposed on the platen glass 22 (platen mode).

The ADF 20 also serves as a cover 46 that covers or exposes the platen glass 22 of the reader 24. A sheet can be disposed on the platen glass 22 when the cover 46 is open, and the sheet on the platen glass 22 can be read when the cover 46 is closed. An open/close detection switch 48 for detecting opening and closing of the cover 46 is also provided.

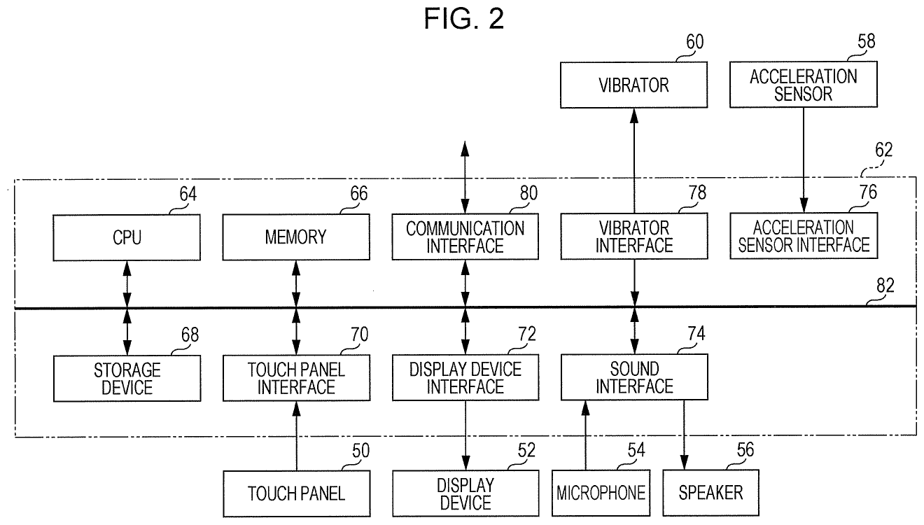

The terminal apparatus 14 is, for example, a smartphone. As illustrated in FIG. 2, the terminal apparatus 14 includes a touch panel 50, which is a contact sensor, a display device 52, which is a liquid crystal display or the like, a microphone 54, which is a sound input device, a speaker 56, which is a sound output device, an acceleration sensor 58 that detects acceleration of the terminal apparatus 14, such as a direction in which the terminal apparatus 14 is shaken, and a vibrator 60, which is a vibration device. The terminal apparatus 14 also includes a control unit 62 that controls the touch panel 50, the display device 52, the microphone 54, the speaker 56, the acceleration sensor 58, the vibrator 60, and the like.

The control unit 62 includes a central processing unit (CPU) 64, a memory 66, a storage device 68, a touch panel interface 70, a display device interface 72, a sound interface 74, an acceleration sensor interface 76, a vibrator interface 78, and a communication interface 80, which are connected to one another by a bus 82.

The CPU 64 performs predetermined processes on the basis of control programs stored in the memory 66. The storage device 68 is a hard disk drive, for example, and stores necessary software and data. The touch panel interface 70 is connected to the touch panel 50 and receives operation data from the touch panel 50. The display device interface 72 is connected to the display device 52 and outputs display data to the display device 52. The sound interface 74 is connected to the microphone 54 and the speaker 56 and receives sound data from the microphone 54 and outputs sound data to the speaker 56. The acceleration sensor interface 76 is connected to the acceleration sensor 58 and receives acceleration data from the acceleration sensor 58. The vibrator interface 78 is connected to the vibrator 60 and controls driving of the vibrator 60.

The communication interface 80 supports Wi-Fi (registered trademark of the Wi-Fi Alliance (an industrial organization based in the United States); refers to mutual connection technologies between devices conforming to the Institute of Electrical and Electronics Engineers (IEEE) 802.11 family of standards, which are international standard specifications), Bluetooth (registered trademark; standardized as “IEEE 802.15.1” by the IEEE and used to communicate information using radio waves between information devices away from each other by several meters to tens of meters), or the like and is connected to the image forming apparatus 12 wirelessly.

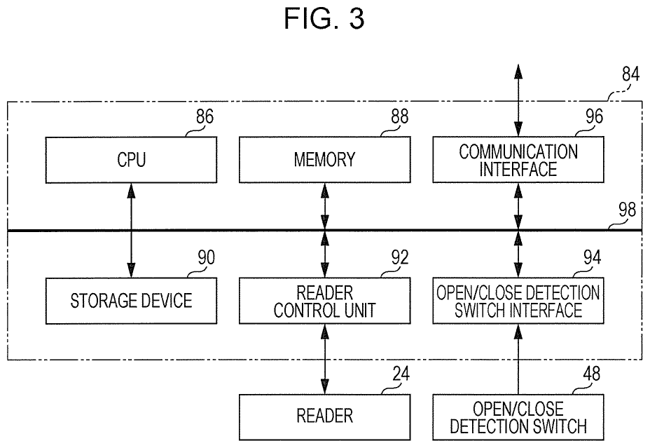

FIG. 3 illustrates a control unit 84 of the image forming apparatus 12.

The control unit 84 includes a CPU 86, a memory 88, a storage device 90, a reader control unit 92, an open/close detection switch interface 94, and a communication interface 96, which are connected to one another by a bus 98.

The CPU 86, the memory 88, the storage device 90, and the communication interface 96 are the same as in the terminal apparatus 14. The reader control unit 92 controls driving sources of the reader 24 and the image reading unit 44. The open/close detection switch interface 94 is connected to the open/close detection switch 48 and receives detection signals from the open/close detection switch 48.

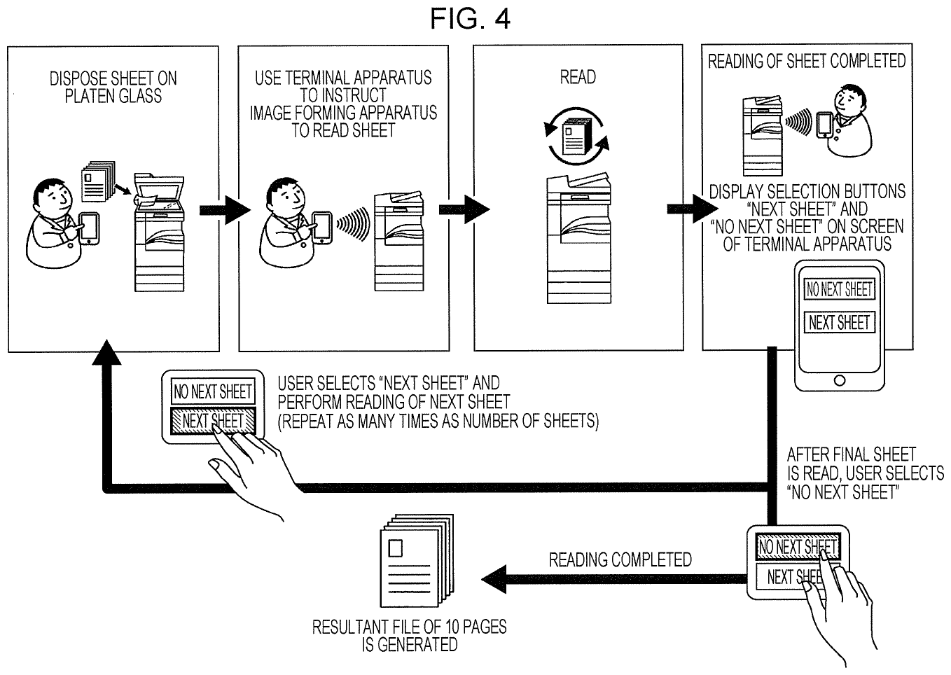

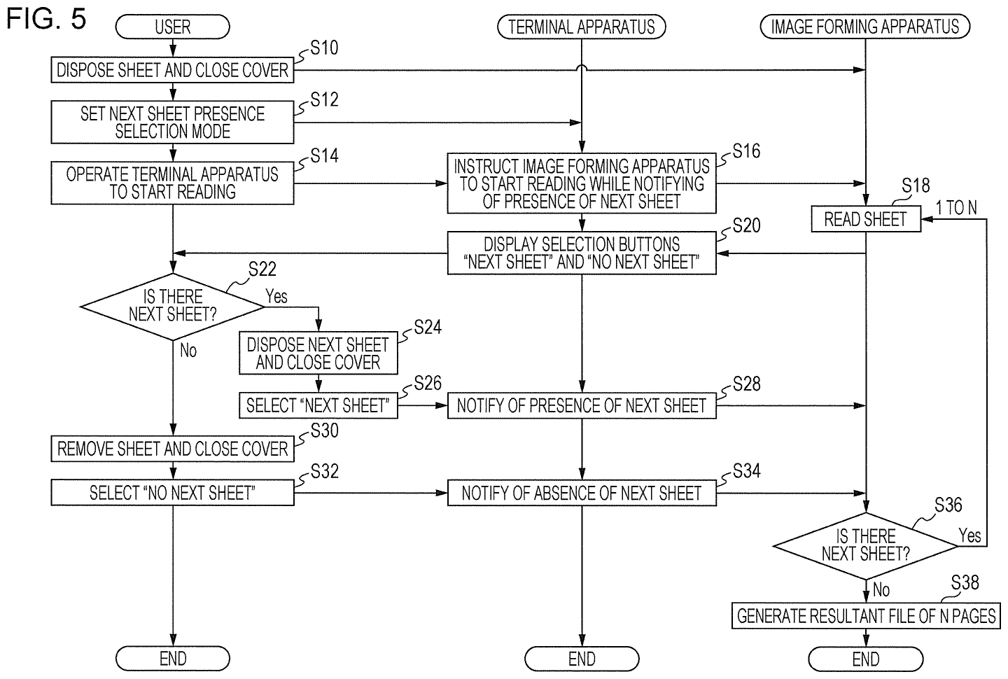

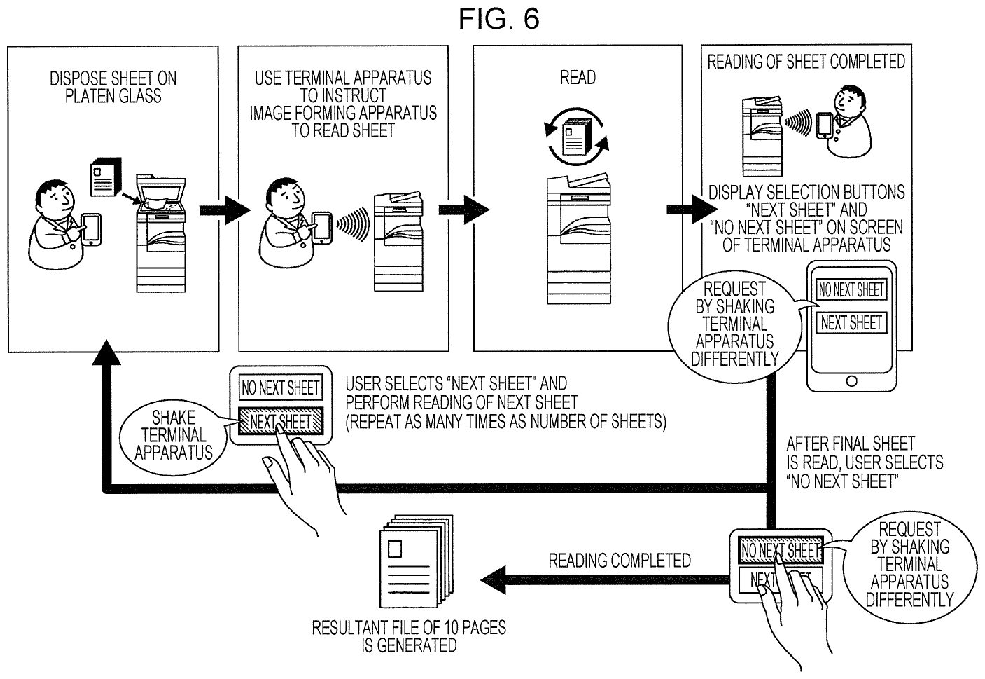

FIGS. 4 and 5 illustrate an operation flow of the image reading system 10 according to a first exemplary embodiment of the present disclosure.

It is assumed that the image forming apparatus 12 has entered the platen mode.

First, in step S10, a user opens the cover 46 of the image forming apparatus 12, disposes a sheet on the platen glass 22, and closes the cover 46. When the user has closed the cover 46, the image forming apparatus 12 detects the closing of the cover 46 on the basis of a signal from the open/close detection switch 48. In step S12, the user sets a next sheet presence selection mode as an operation instruction setting of the image forming apparatus 12. In the next sheet presence selection mode, the user can select whether there is a next sheet. “No next sheet” is set as a default setting of the image forming apparatus 12, and there is no option to select “next sheet” at this time. A next sheet presence setting button, for example, is displayed on the display device 52 of the terminal apparatus 14, and the user touches a part of the touch panel 50 in which the next sheet presence setting button is displayed. As a result, the speaker 56 outputs a message, “This is the next sheet presence setting button”, for example, and the user taps the part twice to set the next sheet presence selection mode.

In step S14, the user performs an operation for starting reading. Here, too, a reading start button is displayed on the display device 52 of the terminal apparatus 14, and the user presses the reading start button to start reading. In step S16, the terminal apparatus 14 instructs the image forming apparatus 12 to start reading while notifying the image forming apparatus 12 of the presence of the next sheet. In step S18, the image forming apparatus 12 reads the sheet.

After reading the sheet in step S18, the image forming apparatus 12 notifies the terminal apparatus 14 of completion of the reading of the sheet. The terminal apparatus 14 displays information indicating the completion of the reading or notifies the user of the completion of the reading with a sound output from the speaker 56. In step S20, the display device 52 of the terminal apparatus 14 displays selection buttons “next sheet” and “no next sheet”.

In step S22, the user determines whether there is a next sheet. If determining in step S22 that there is a next sheet, the user replaces the sheet on the platen glass 22 with the next sheet and closes the cover 46 in step S24. In step S26, the user selects “next sheet”. In step S28, the terminal apparatus 14 notifies the image forming apparatus 12 of the presence of the next sheet.

If determining in step S22 that there is no next sheet, on the other hand, the user removes the sheet from the platen glass 22 and closes the cover 46 in step S30. In step S32, the user selects “no next sheet”. In step S34, the terminal apparatus 14 notifies the image forming apparatus 12 of the absence of a next sheet. In step S36, the image forming apparatus 12 determines whether there is a next sheet. If the image forming apparatus 12 determines in step S36 that there is a next sheet, the process returns to step S18, and the image forming apparatus 12 reads the sheet. This process is repeated N times (N is the number of pages to be included in a resultant file). If the image forming apparatus 12 determines in step S36 that there is no next sheet, on the other hand, the process proceeds to step S38, and the image forming apparatus 12 generates a file of N pages. The process thus ends. If the image forming apparatus 12 has determined ten times that there is a next sheet, for example, the image forming apparatus 12 generates a file of 10 pages.

Although the user determines whether there is a next sheet in the first exemplary embodiment, a factor of time may also be involved. That is, if a certain period of time has elapsed since the cover 46 was closed last time, the image forming apparatus 12 may determine that there is no next sheet, and the process for generating a file may end. If the certain period of time has not elapsed yet since the cover 46 was closed last time, the image forming apparatus 12 may keep determining that there is a next sheet. If a certain period of time has elapsed since the user selected “next sheet” using the terminal apparatus 14 last time, the terminal apparatus 14 may notify the image forming apparatus 12 of absence of a next sheet. If the certain period of time has not elapsed yet since the user selected “next sheet” using the terminal apparatus 14 last time, the terminal apparatus 14 may keep notifying the image forming apparatus 12 of presence of a next sheet. Furthermore, if the cover 46 is closed after a previous sheet is read, the process for generating a file may be immediately performed and then end.

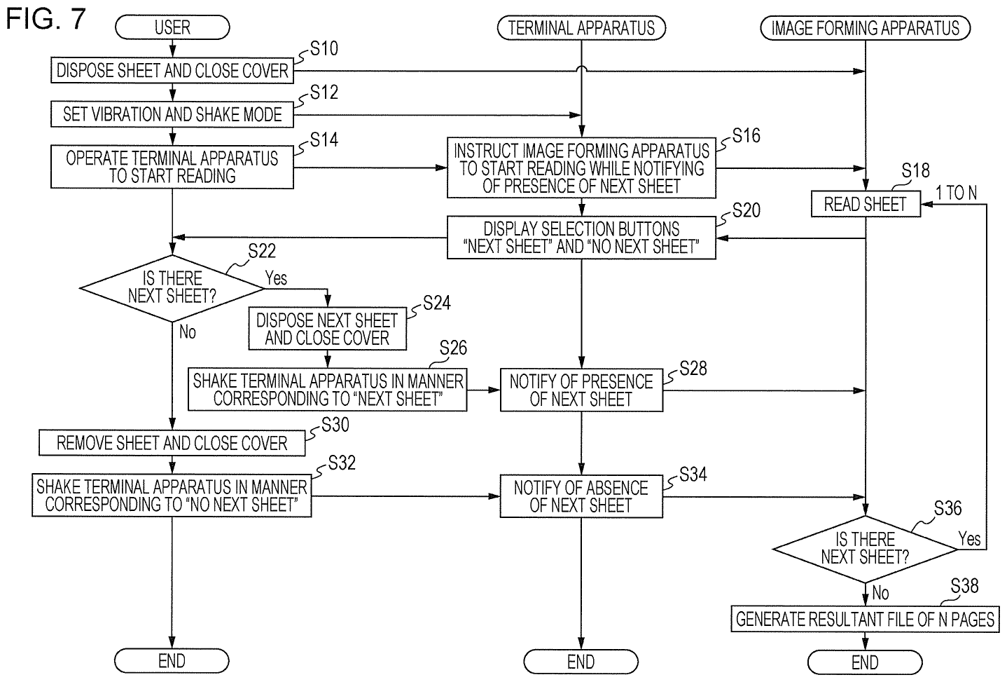

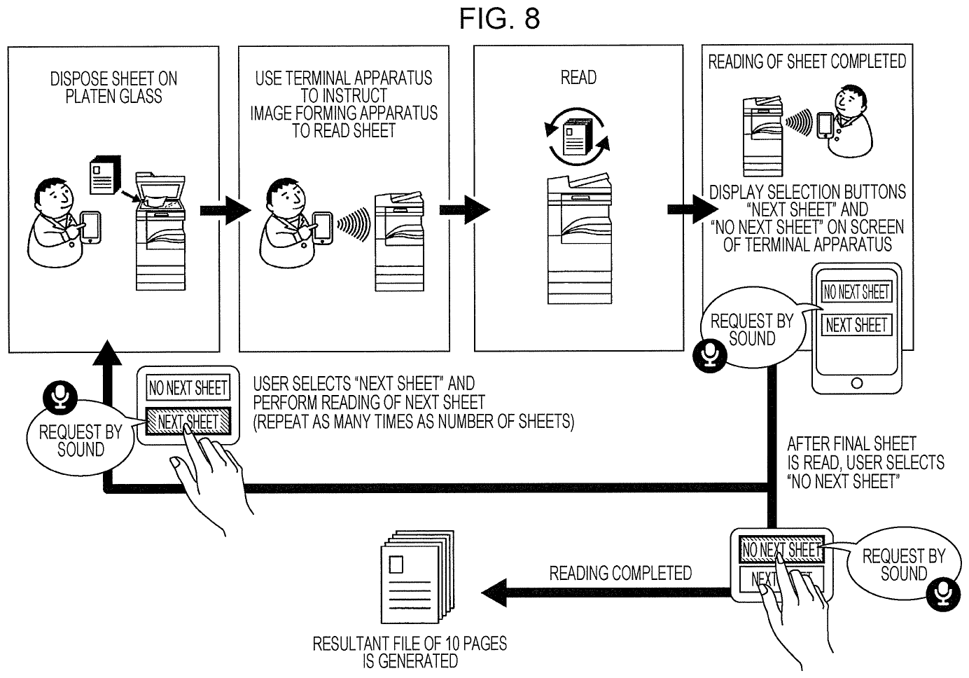

FIGS. 6 and 7 illustrate an operation flow of the image reading system 10 according to a second exemplary embodiment of the present disclosure.

The second exemplary embodiment is different from the first exemplary embodiment in terms of steps S12, S26, and S32.

In the second exemplary embodiment, the user sets a vibration and shake mode in step S12. In the vibration and shake mode, the vibrator 60 notifies the user of information through vibration and the acceleration sensor 58 receives the user's instructions. After the user sets the vibration and shake mode in step S12, the terminal apparatus 14 notifies the user of information using the vibrator 60 and instructs the image forming apparatus 12 to perform operations in accordance with shaking of the terminal apparatus 14 performed by the user.

In step S20, the image forming apparatus 12 notifies the terminal apparatus 14 of completion of reading of a sheet, and the terminal apparatus 14 in turn notifies the user of the completion of the reading of the sheet through characteristic vibration.

If the user determines in step S22 that there is a next sheet, the user shakes the terminal apparatus 14 in step S26 in a manner corresponding to “next sheet”. If the user shakes the terminal apparatus 14 vertically, for example, the acceleration sensor 58 detects vertical acceleration, that is, “next sheet”, and notifies the image forming apparatus 12 of the presence of the next sheet in step S28.

If the user determines in step S22 that there is no next sheet, on the other hand, the user shakes the terminal apparatus 14 in step S26 in a manner corresponding to “no next sheet”. If the user shakes the terminal apparatus 14 horizontally, for example, the acceleration sensor 58 detects horizontal acceleration, that is, “no next sheet”, and notifies the image forming apparatus 12 of the absence of a next sheet in step S34.

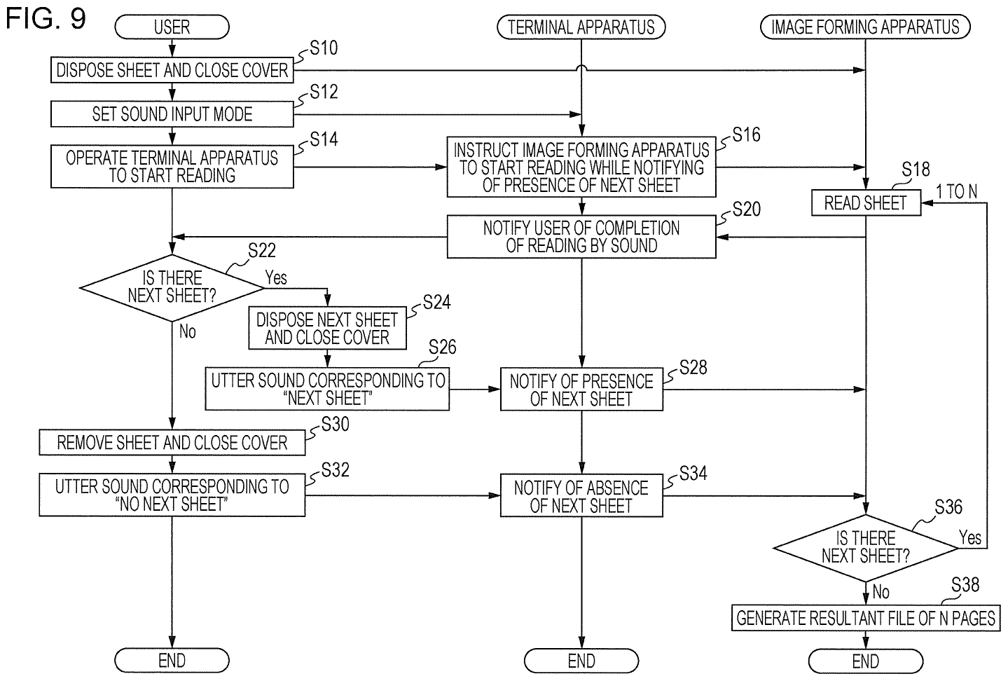

FIGS. 8 and 9 illustrate an operation flow of the image reading system 10 according to a third exemplary embodiment of the present disclosure.

The third exemplary embodiment is different from the first and second exemplary embodiments in terms of steps S12, S26, and S32.

In the third exemplary embodiment, the user sets a sound input mode in step S12. In the sound input mode, the user gives instructions with sounds input to the microphone 54, and the terminal apparatus 14 notifies the user of information with sounds output from the speaker 56. After the user sets the sound input mode in step S12, the terminal apparatus 14 notifies the user of information using the speaker 56 and instructs the image forming apparatus 12 to perform operations in accordance with sounds input by the user to the microphone 54.

In step S20, the image forming apparatus 12 notifies the terminal apparatus 14 of completion of reading of a sheet, and the terminal apparatus 14 in turn notifies the user of the completion of the reading of the sheet with a sound output from the speaker 56.

If the user determines in step S22 that there is a next sheet, the user utters a sound corresponding to “next sheet” in step S26.

If the user determines in step S22 that there is no next sheet, on the other hand, the user utters a sound corresponding to “no next sheet” in step S26.

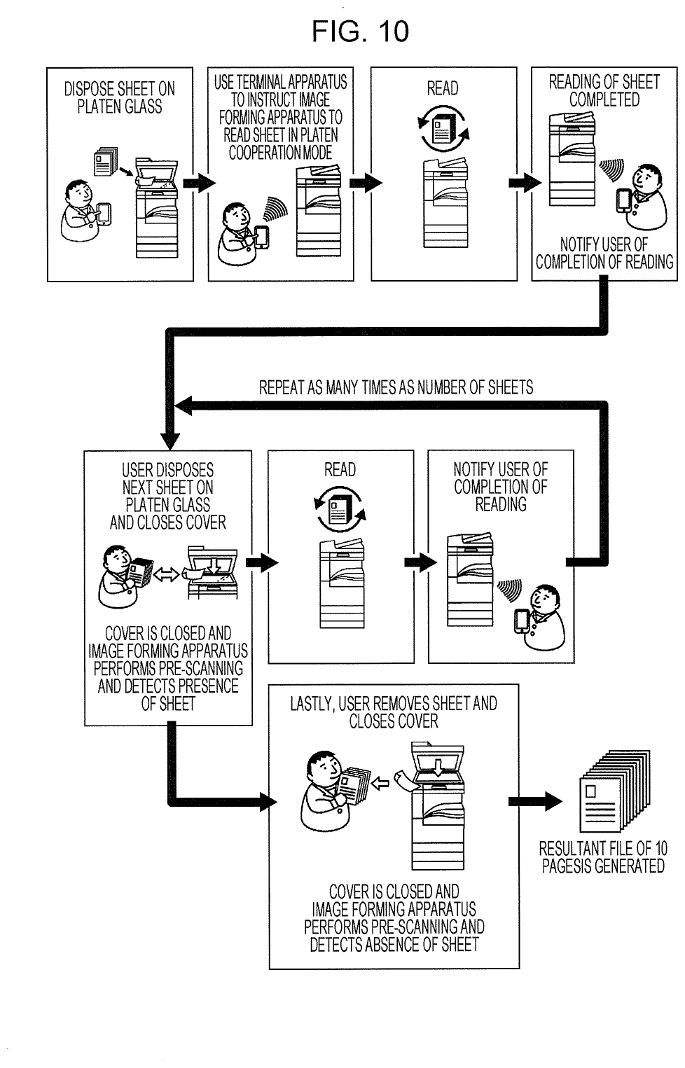

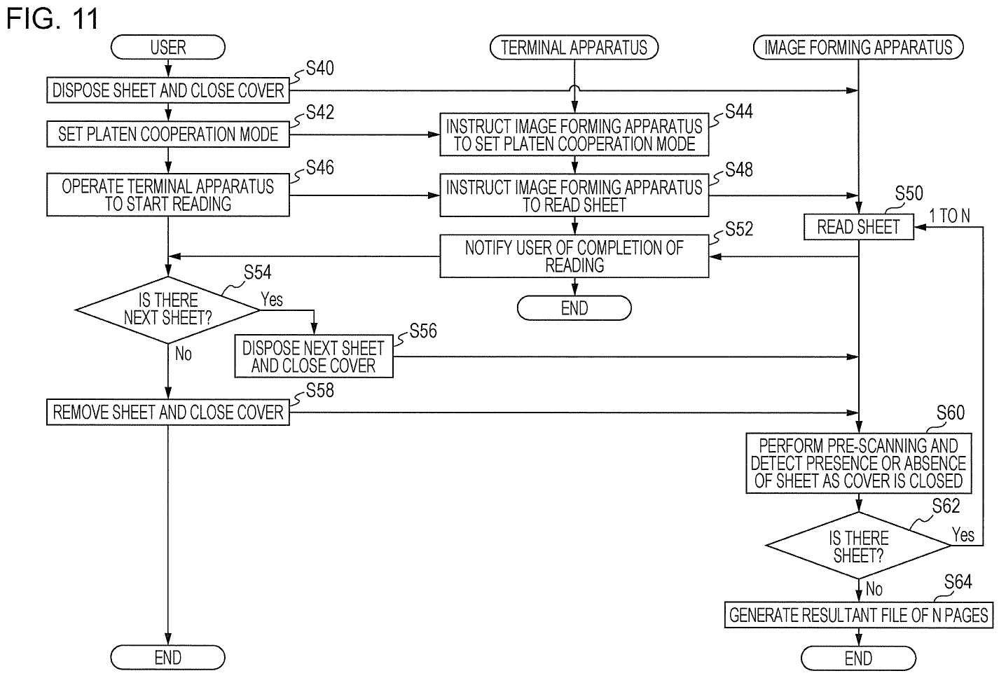

FIGS. 10 and 11 illustrate an operation flow of the image reading system 10 according to the fourth exemplary embodiment of the present disclosure.

The fourth exemplary embodiment is different from the first to third exemplary embodiments in that the image reading system 10 is controlled in a platen cooperation mode. In the platen cooperation mode, whether there is a next sheet is determined through opening or closing of the cover 46 and pre-scanning performed by the image reading unit 44.

First, in step S40, the user opens the cover 46 of the image forming apparatus 12, disposes a sheet on the platen glass 22, and closes the cover 46. When the user has closed the cover 46, the image forming apparatus 12 detects the closing of the cover 46 on the basis of a signal from the open/close detection switch 48. In step S42, the user sets the platen cooperation mode as an operation instruction setting of the image forming apparatus 12. A platen cooperation mode setting button, for example, is displayed on the display device 52 of the terminal apparatus 14, and the user touches a part of the touch panel 50 in which the platen cooperation mode setting button is displayed. As a result, the speaker 56 outputs a message, “This is the platen cooperation mode setting button”, for example, and the user taps the part twice to set the platen cooperation mode. In step S44, the terminal apparatus 14 instructs the image forming apparatus 12 to set the platen cooperation mode.

In step S46, the user performs an operation for starting reading. Here, too, a reading start button is displayed on the display device 52 of the terminal apparatus 14, and the user presses the reading start button to start reading. In step S48, the terminal apparatus 14 instructs the image forming apparatus 12 to start reading, and in step S50, the image forming apparatus 12 reads the sheet.

After reading the sheet in step S50, the image forming apparatus 12 notifies the terminal apparatus 14 of completion of the reading of the sheet. In step S52, the terminal apparatus 14 displays information indicating the completion of the reading or notifies the user of the completion of the reading with a sound output from the speaker 56.

In step S54, the user determines whether there is a next sheet. If determining in step S54 that there is a next sheet, the user replaces the sheet on the platen glass 22 with the next sheet and closes the cover 46 in step S56. If determining in step S54 that there is no next sheet, on the other hand, the user closes the cover 46 in step S58 without replacing the sheet. In step S60, the image forming apparatus 12 detects the closing of the cover 46 with the open/close detection switch 48 and performs pre-scanning. The pre-scanning is a process for determining, before reading an image on a sheet, whether a sheet is disposed and, if so, the size of the sheet. The pre-scanning is performed by moving the image reading unit 44.

In step S62, the image forming apparatus 12 determines whether there is a sheet. When there is a sheet on the platen glass 22, a boundary between the sheet and the cover 46 can be detected, and when there is no sheet, such a boundary does not exist. Whether there is a sheet on the platen glass 22 can therefore be determined.

If the image forming apparatus 12 determines in step S62 that there is a sheet, the process returns to step S50, and the image forming apparatus 12 reads the sheet. This process is repeated N times (N is the number of pages to be included in a resultant file). If the image forming apparatus 12 determines in step S62 that there is no next sheet, on the other hand, the process proceeds to step S64, and the image forming apparatus 12 generates a file of N pages. The process thus ends. If the image forming apparatus 12 has determined ten times that there is a next sheet, for example, the image forming apparatus 12 generates a file of 10 pages.

Although whether there is a next sheet is determined on the basis of opening and closing of the cover 46 in the fourth exemplary embodiment, a factor of time may also be involved. That is, if a certain period of time has not elapsed yet since the cover 46 was closed last time, the image forming apparatus 12 may keep determining that there is a next sheet. The certain period of time in this case may be longer than in other modes.

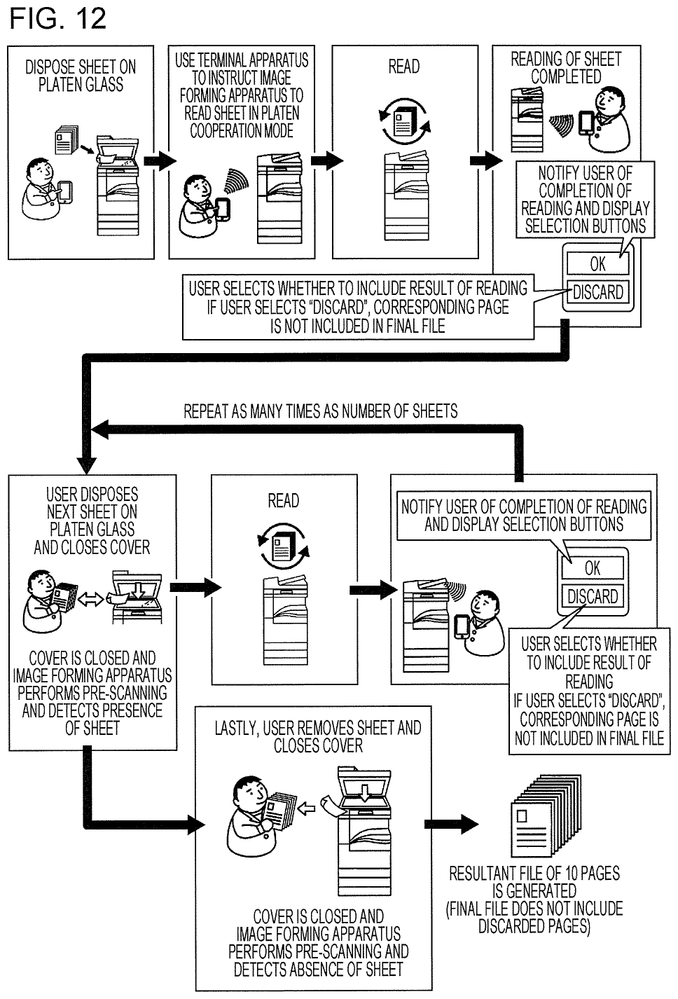

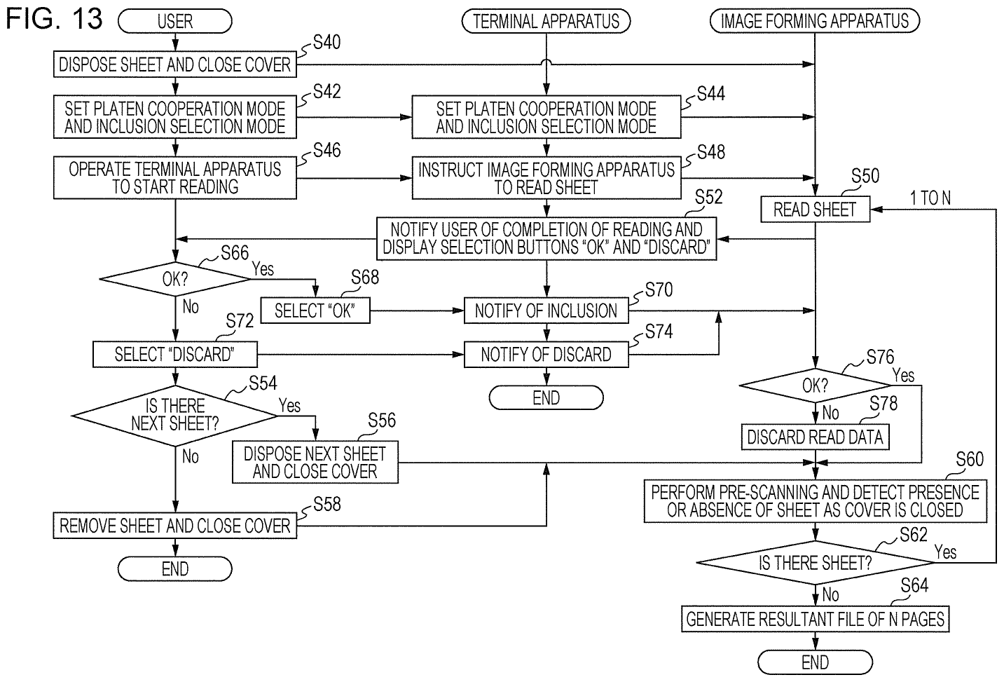

FIGS. 12 and 13 illustrate an operation flow of the image reading system 10 according to a fifth exemplary embodiment of the present disclosure.

The fifth exemplary embodiment is different from the fourth exemplary embodiment in that a function of determining whether to include a read sheet in a resultant file is added.

In the fifth exemplary embodiment, in step S42, the user sets the platen cooperation mode and an inclusion selection mode. In the inclusion selection mode, whether to include a read sheet in a resultant file can be selected. In step S44, the terminal apparatus 14 instructs the image forming apparatus 12 to set the platen cooperation mode and the inclusion selection mode.

In the fifth exemplary embodiment, after reading a sheet in step S50, the image forming apparatus 12 notifies the terminal apparatus 14 of completion of the reading of the sheet. The terminal apparatus 14 displays information indicating the completion of the reading or notifies the user of the completion of the reading with a sound output from the speaker 56. In step S52, the display device 52 of the terminal apparatus 14 displays selection buttons “OK” and “discard”.

In step S66, the user determines whether to include the read sheet in a resultant file. If determining in step S66 that the read sheet is to be included in a resultant file, the user selects “OK” in step S68. If the user selects “OK” in step S68, the terminal apparatus 14 notifies, in step S70, the image forming apparatus 12 of inclusion of the read sheet in the resultant file. If the user selects “discard” in step S72, the terminal apparatus 14 notifies, in step S74, the image forming apparatus 12 of discard of the read sheet.

The user may select “OK” or “discard” by touching the touch panel 50 of the terminal apparatus 14 and following an output audio instruction, shaking the terminal apparatus 14, or uttering a sound.

After the terminal apparatus 14 notifies the image forming apparatus 12 of inclusion or discard in step S70 or S74, the image forming apparatus 12 determines in step S76 whether to use data regarding the read sheet. If the image forming apparatus 12 determines in step S76 that the data is to be used, the process proceeds to step S60. If the image forming apparatus 12 determines in step S76 that the data is not to be used, the process proceeds to step S78, where the data regarding the read sheet is discarded, and then proceeds to step S60. A subsequent process is the same as in the fourth exemplary embodiment.

Since the user determines whether to include or discard a read sheet in the fifth exemplary embodiment, a resultant file can be neatly edited.

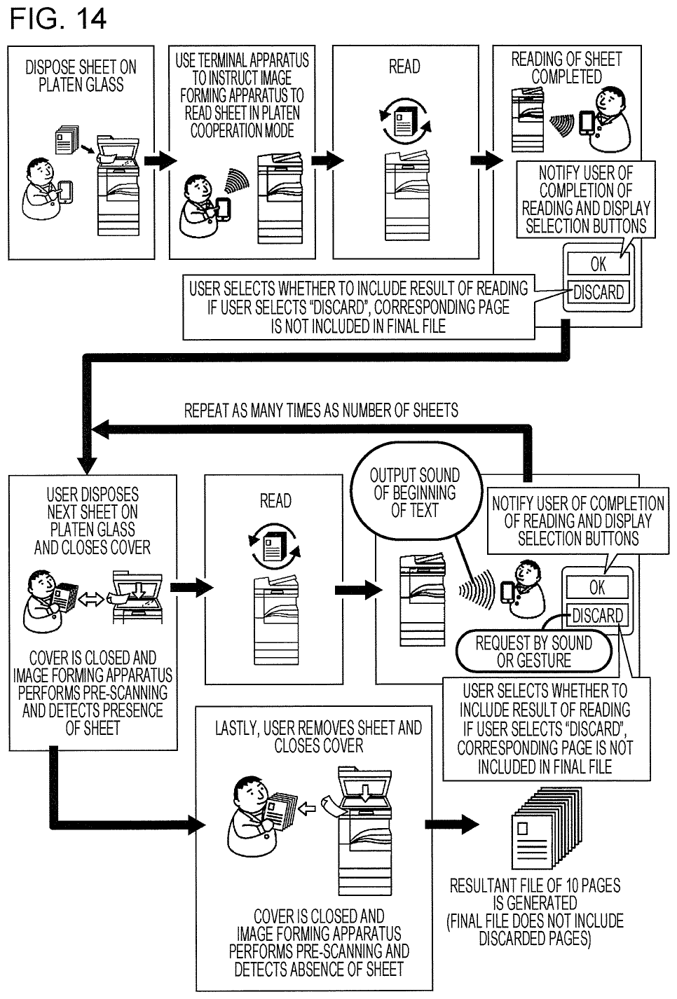

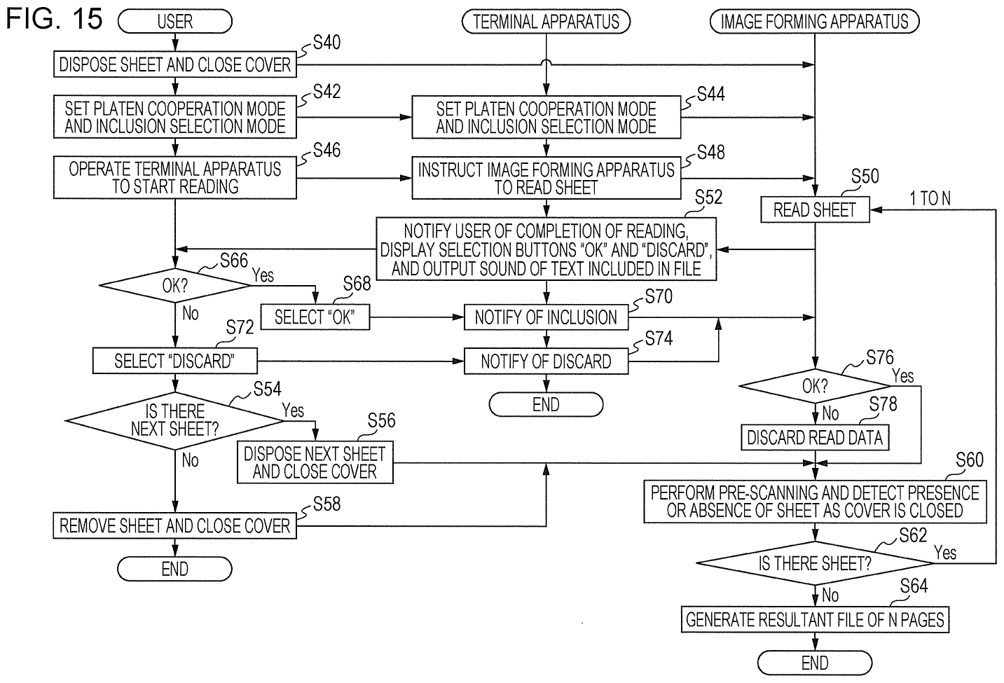

FIGS. 14 and 15 illustrate an operation flow of the image reading system 10 according to a sixth exemplary embodiment of the present disclosure.

The sixth exemplary embodiment is different from the fifth exemplary embodiment in that, in step S52, the terminal apparatus 14 outputs a sound of text included in a read sheet while displaying “OK” and “discard”.

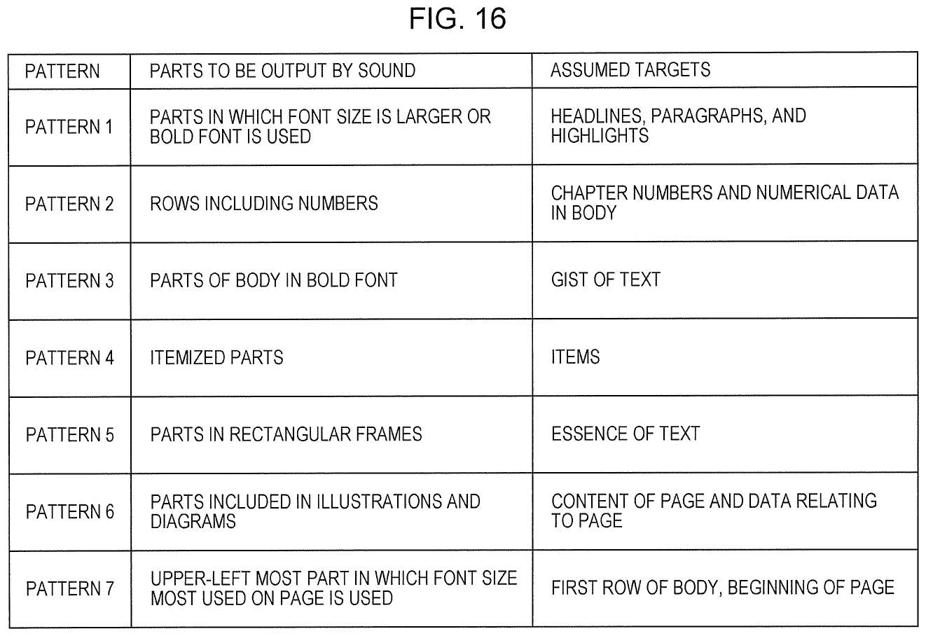

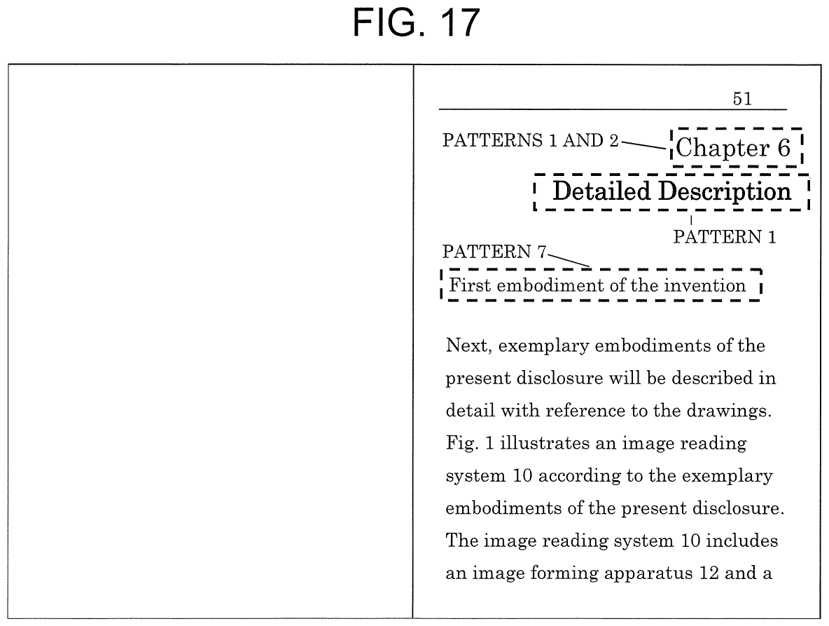

In the sixth exemplary embodiment, a sound of the entirety of text included in a read sheet may be output. As illustrated in FIG. 16, however, parts of a read sheet may be extracted using one of patterns and sounds of the parts may be output, instead.

Pattern 1: Parts in which font size is larger or a bold font is used. For example, headlines, paragraphs, and highlights.

Pattern 2: Rows including numbers. Chapter numbers and numerical data in a body.

Pattern 3: Parts of a body in a bold font, which are emphasized parts and indicate the gist of text. Parts in a different color, underscored parts, and the like may also apply.

Pattern 4: Itemized parts.

Pattern 5: Parts in rectangular frames, which indicate the essence of text.

Pattern 6: Parts included in illustrations and diagrams, which indicate content of a page and data relating to the page, respectively.

Pattern 7: An upper-leftmost part in which a font size most used on a page is used.

These images are extracted from a read sheet, and text data is generated from the extracted images. The text data is converted into audio data and output as sounds.

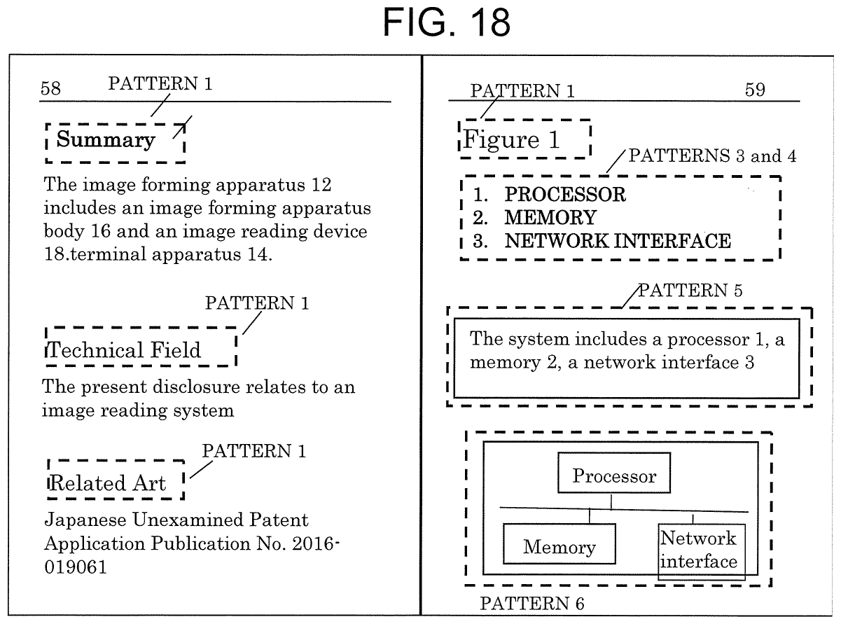

FIGS. 17 to 18 illustrate examples of application of the above patterns.

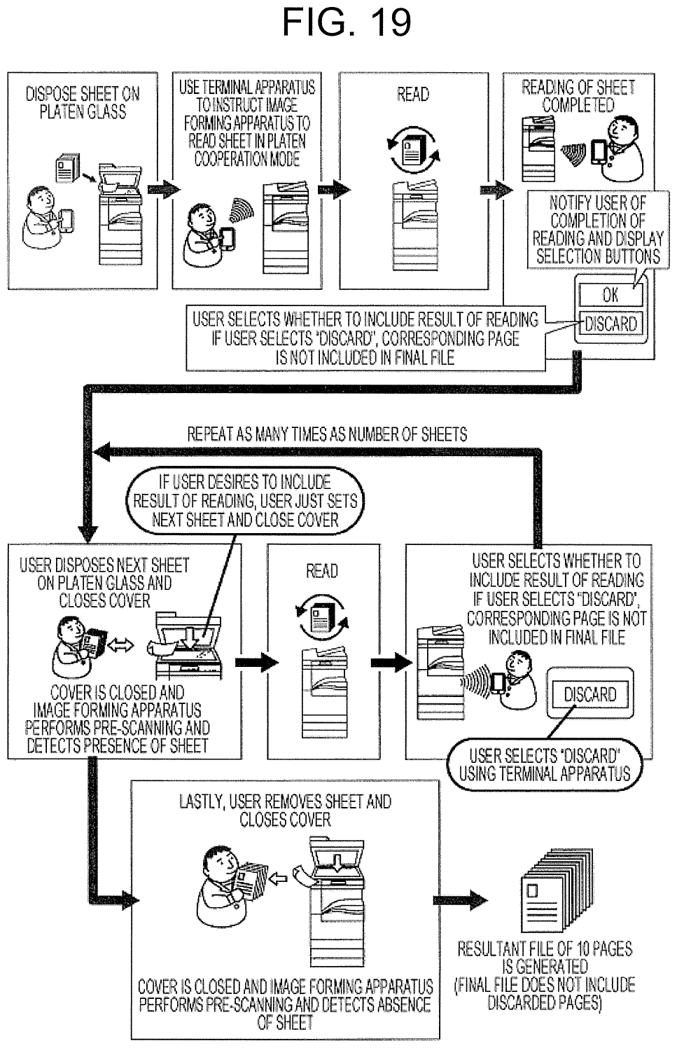

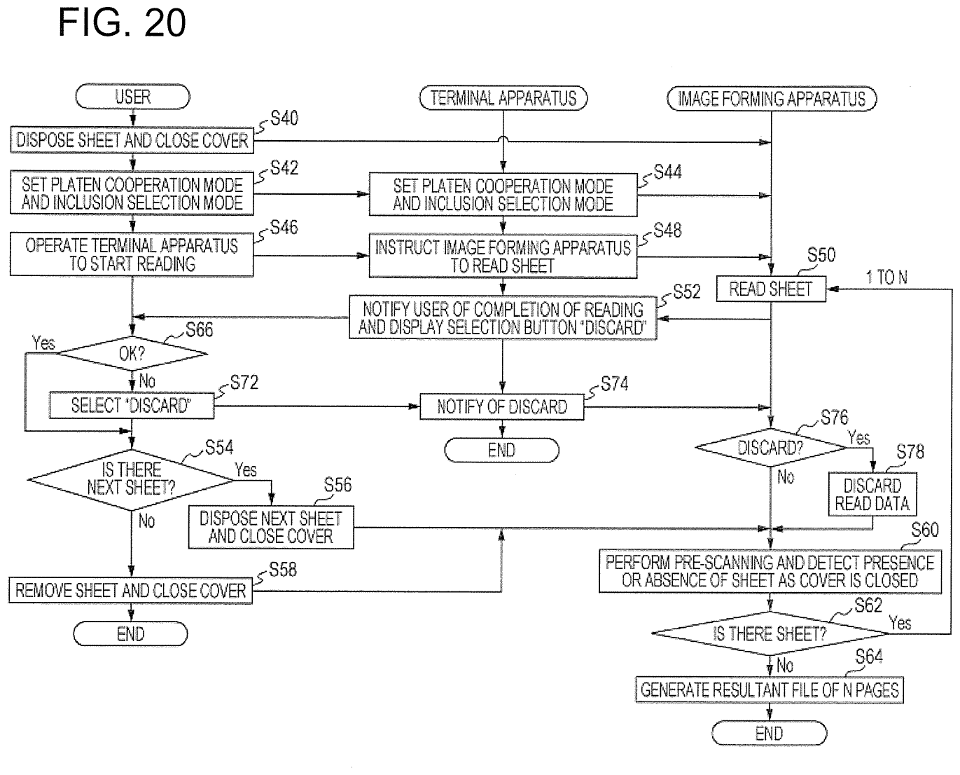

FIGS. 19 and 20 illustrate an operation flow of the image reading system 10 according to a seventh exemplary embodiment of the present disclosure.

Whereas the terminal apparatus 14 displays “OK” and “discard” in step S52 and the user selects either “OK” or “discard” in the sixth exemplary embodiment, the terminal apparatus 14 displays only “discard” in step S52 in the seventh exemplary embodiment. If the user selects “discard”, data regarding a read sheet is discarded in step S78. If the user replaces a sheet and closes the cover 46 in step S56, it is determined that the user has selected “OK”, and a read sheet is included in a resultant file.

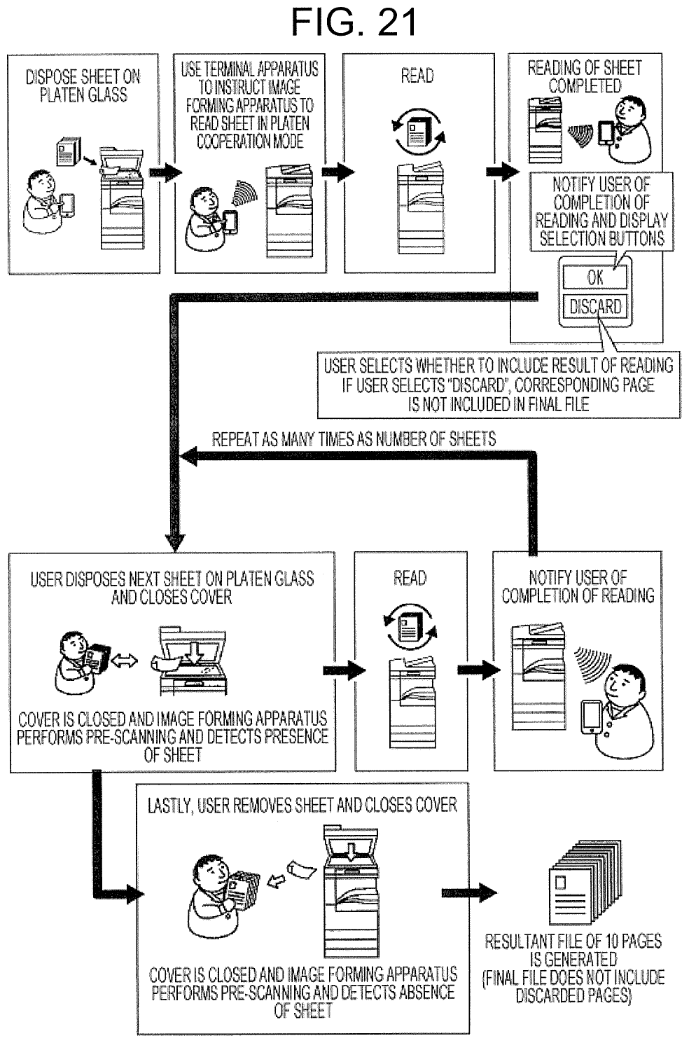

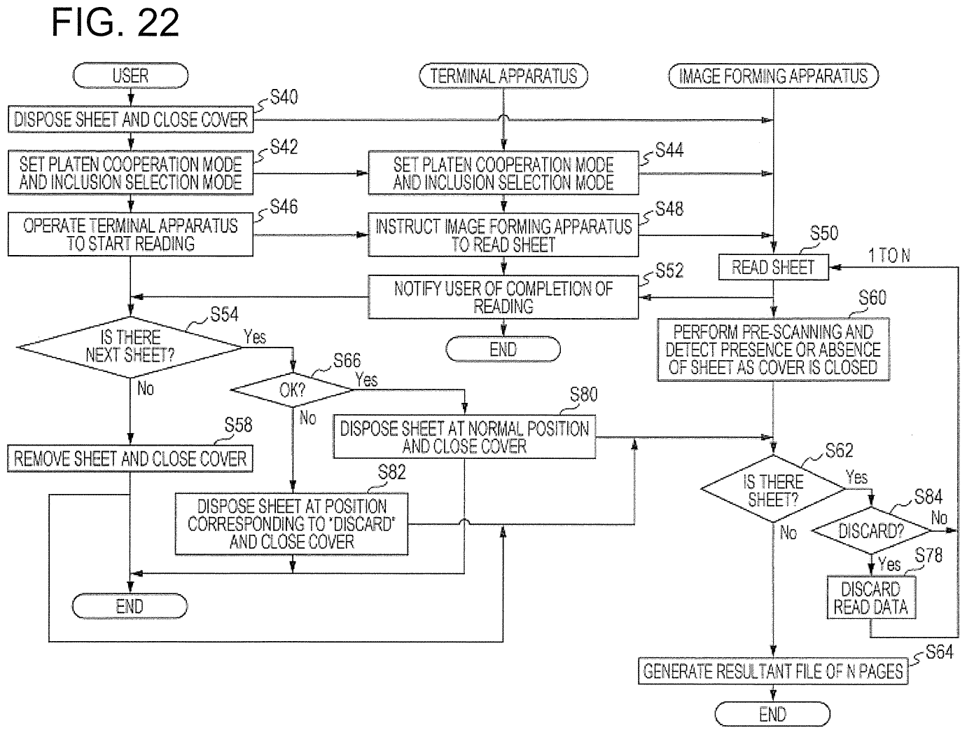

FIGS. 21 and 22 illustrate an operation flow of the image reading system 10 according to an eighth exemplary embodiment of the present disclosure.

Whereas the user selects “OK” or “discard” using the terminal apparatus 14 in the sixth and seventh exemplary embodiments, whether a read sheet is to be included in a resultant file is determined on the basis of a position at which a next sheet is disposed on the platen glass 22 in the eighth exemplary embodiment.

That is, in the eighth exemplary embodiment, the user determines in step S54 whether there is a next sheet. If selecting “OK” in step S66, the user removes the read sheet, disposes a next sheet at a normal position, and closes the cover 46 in step S80. If selecting “discard” in step S66, on the other hand, the user removes the read sheet, disposes a next sheet at a position corresponding to “discard”, and closes the cover 46. The position corresponding to “discard” is a position other than the normal position. For example, the user may dispose the next sheet 180° angled from the normal position, dispose the next sheet obliquely, or dispose the next sheet at a position at which only a part of the sheet is read. Alternatively, the user may dispose a blank sheet.

In step S60, the image forming apparatus 12 performs pre-scanning in cooperation with the cover 46, but the image forming apparatus 12 detects not only presence or absence of a sheet but also a position of the sheet. In step S62, the image forming apparatus 12 determines whether there is a sheet. If the image forming apparatus 12 determines in step S62 that there is a sheet, the process proceeds to step S84. In step S84, the image forming apparatus 12 determines whether the sheet is disposed at the position corresponding to “discard”. If the image forming apparatus 12 determines in step S84 that the sheet is disposed at the position corresponding to “discard”, the process proceeds to step S78, and the image forming apparatus 12 discards data regarding the read sheet.

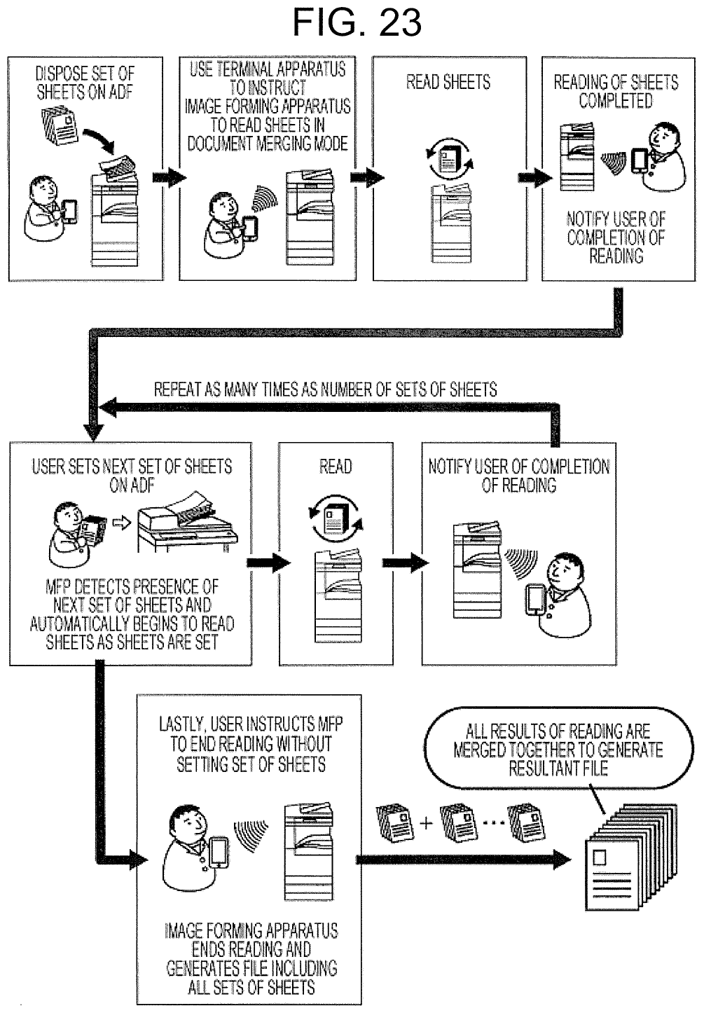

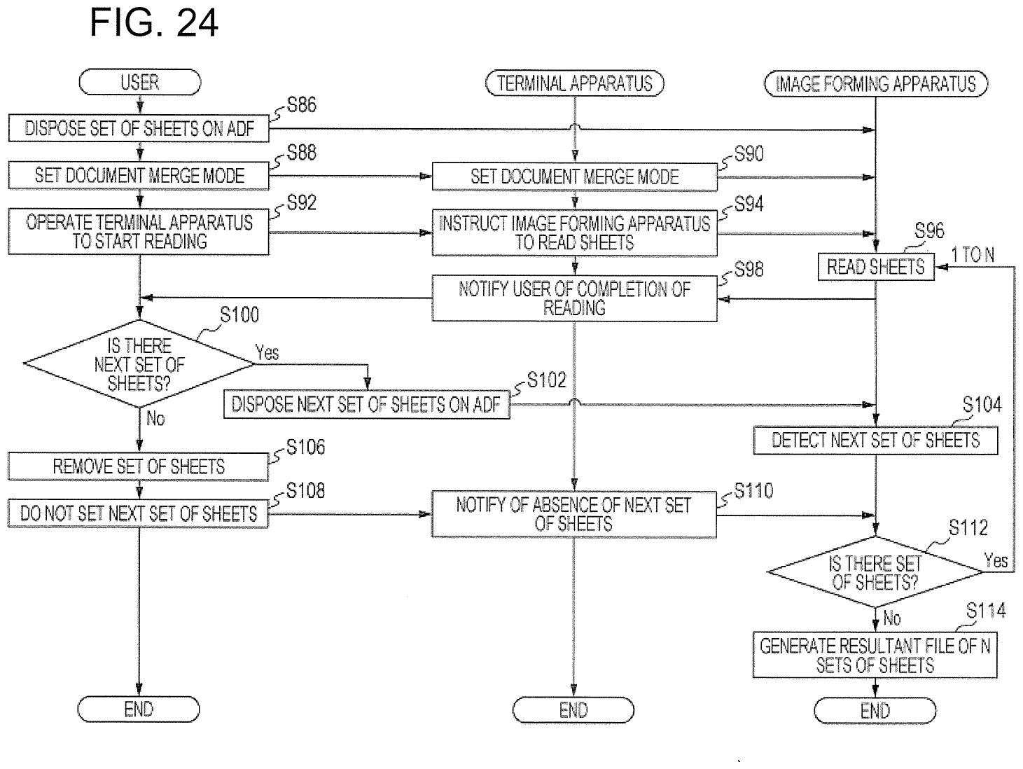

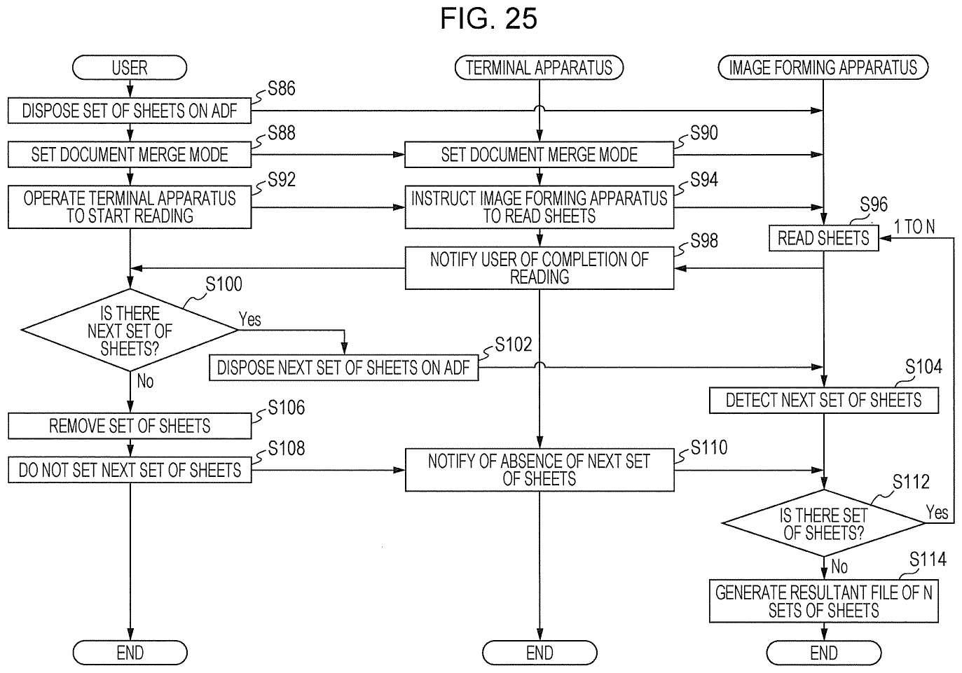

FIGS. 23 and 24 illustrate an operation flow of the image reading system 10 according to a ninth exemplary embodiment of the present disclosure.

It is assumed that the image forming apparatus 12 has entered the ADF mode.

First, in step S86, the user disposes a set of sheets on the document support 26 of the ADF 20. In step S88, the user sets an ADF merge mode. In the ADF merge mode, which can be set in the ADF mode, a set of sheets read in a previous operation and a set of sheets read in a current operation are merged together. After the user sets the ADF merge mode in step S88, the terminal apparatus 14 instructs the image forming apparatus 12 to set the ADF merge mode in step S90.

In step S92, the user performs an operation for starting reading. In step S94, the terminal apparatus 14 instructs the image forming apparatus 12 to start reading, and in step S96, the image forming apparatus 12 reads the first set of sheets.

After reading the first set of sheets in step S96, the image forming apparatus 12 notifies the terminal apparatus 14 of completion of the reading of the set of sheets. In step S98, the terminal apparatus 14 displays information indicating the completion of the reading or notifies the user of the completion of the reading with a sound output from the speaker 56. In step S98, the display device 52 of the terminal apparatus 14 displays selection buttons “next set” and “no next set”.

In step S100, the user determines whether there is a next set of sheets. If determining in step S100 that there is a next set of sheets, the user disposes the next set of sheets on the document support 26 in step S102. In step S104, the image forming apparatus 12 detects the next set of sheets on the document support 26. If the determining in step S100 that there is no next set of sheets, the user removes the first set of sheets output to the output tray 28 in step S106. In step S108, the user selects “no next set”. In step S110, the terminal apparatus 14 notifies the image forming apparatus 12 of the absence of a next set of sheets. In step S112, the image forming apparatus 12 determines whether there is a next set of sheets. If the image forming apparatus 12 determines in step S112 that there is a next set of sheets, the process returns to step S96, and the image forming apparatus 12 reads the next set of sheets. This process is repeated N times. If the image forming apparatus 12 determines in step S112 that there is no next set of sheets, on the other hand, the process proceeds to step S114, and the image forming apparatus 12 generates a file of N sets of sheets. The process thus ends.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image reading system comprising:
a terminal apparatus; and
an image reading apparatus that communicates data with the terminal apparatus and reads a sheet,
wherein the terminal apparatus includes an operation instruction unit that instructs the image reading apparatus to perform an operation, and
wherein either the terminal apparatus or the image reading apparatus includes a notification unit that notifies a user of completion of reading of the sheet and a next sheet instruction unit used by the user to determine whether to read a next sheet and include the next sheet in a resultant file in which the sheet is included.

2. The image reading system according to claim 1,
wherein the notification unit is provided in the terminal apparatus.

3. The image reading system according to claim 2,
wherein the terminal apparatus includes a display device that displays an image, and
wherein the notification unit notifies the user of the completion of the reading by displaying the image on the display device.

4. The image reading system according to claim 2,
wherein the terminal apparatus includes a vibration device that vibrates the terminal apparatus, and
wherein the notification unit notifies the user of the completion of the reading by vibrating the terminal apparatus using the vibration device.

5. The image reading system according to claim 2,
wherein the terminal apparatus includes a sound output device that outputs a sound, and
wherein the notification unit notifies the user of the completion of the reading with the sound output from the sound output device.

6. The image reading system according to claim 1,
wherein the next sheet instruction unit is provided in the terminal apparatus.

7. The image reading system according to claim 6,
wherein the terminal apparatus includes a contact sensor that inputs a signal if the user touches the contact sensor, and
wherein the next sheet instruction unit is used by the user to determine whether to read the next sheet and include the next sheet in the resultant file by touching the contact sensor.

8. The image reading system according to claim 6,
wherein the terminal apparatus includes an acceleration detection unit that detects acceleration of the terminal apparatus, and
wherein the next sheet instruction unit is used by the user to determine whether to read the next sheet and include the next sheet in the resultant file by shaking the terminal apparatus, the shaking being detected by the acceleration detection unit.

9. The image reading system according to claim 2,
wherein the terminal apparatus includes a sound input device that receives a sound, and
wherein the next sheet instruction unit is used by the user to determine whether to read the next sheet and include the next sheet in the resultant file by inputting the sound to the sound input device.

10. The image reading system according to claim 1,
wherein the image reading apparatus includes a platen glass on which the sheet is disposed and a cover that covers or exposes the platen glass, and
wherein the operation instruction unit instructs the image reading apparatus to read the sheet in cooperation with the cover.

11. The image reading system according to claim 10,
wherein the image reading apparatus includes a control unit that again checks, after the cover is opened, whether there is a sheet and that, if there is a sheet, reads the sheet or that, if there is no sheet, generates the resultant file including the sheet that has been read and ends a process.

12. The image reading system according to claim 1,
wherein the terminal apparatus further includes a discard instruction unit that instructs the image reading apparatus whether to discard the read sheet.

13. The image reading system according to claim 12,
wherein the terminal apparatus includes a sound output unit that outputs a sound, and
wherein the sound output unit outputs a sound of at least a part of text included in the read sheet.

14. The image reading system according to claim 1,
wherein the image reading apparatus includes an automatic document feeder that feeds a plurality of sheets included in a set of sheets one by one, and
wherein the operation instruction unit instructs the image reading apparatus to read a next set of sheets after reading the set of sheets.

15. An image reading system comprising:
terminal means; and
image reading means for communicating data with the terminal means and reading a sheet,
wherein the terminal means includes operation instruction means for instructing the image reading means to perform an operation, and
wherein either the terminal means or the image reading means includes notification means for notifying a user of completion of reading of the sheet and next sheet instruction means used by the user to determine whether to read a next sheet and include the next sheet in a resultant file in which the sheet is included.
